(19) United States
(12) Patent Application Publication
(10) Pub. No.: US 2025/0204317 A1
(43) Pub. Date: Jun. 26, 2025

(54) Vision Based Quality Loss Measurement

(71) Applicant: AGCO Corporation, Duluth, GA (US)

(72) Inventors: Kevin J. Hamilton, Newton, KS (US); Donald Gilles, Hesston, KS (US)

(21) Appl. No.: 18/957,097

(22) Filed: Nov. 22, 2024

Related U.S. Application Data
(60) Provisional application No. 63/613,812, filed on Dec. 22, 2023.

(51) Int. Cl. A01D 43/10

(52) U.S. Cl. CPC A01D 43/102

(57) ABSTRACT

Systems and methods are provided for monitoring and controlling operation a conditioning system of or otherwise associated with an agricultural machine, which may include a mower conditioner. Both pre-conditioning and post-conditioning sensor data indicative of a first and second measurable properties of crop material to be processed and processed by the conditioning system, respectively, are used to determine a crop conditioning metric. Operation of one or more components associated with the conditioning system can then be controlled in dependence on the determined crop conditioning metric. Advantageously, crop properties pre and post conditioning by the conditioning system define a control input for the conditioner or components associated therewith.

### CROSS-REFERENCE TO RELATED APPLICATIONS

This application claims the benefit of the filing date of U.S. Provisional Patent Application No. 63/613,812, “Crop Conditioning,” filed 21 Dec. 2023, the entire disclosure of which is incorporated herein by reference.

### FIELD

Embodiments of the present disclosure relate generally to control systems and methods for an agricultural machine or components thereof, and specifically for monitoring and controlling operation of a conditioning system of or otherwise associated with the machine.

### BACKGROUND

An important process in the harvesting or collection of certain crops is the processing or “conditioning” of the material. Typically, for forage crops such as alfalfa and the like, the crop is cut and “conditioned” through application of a mechanical force to the crop material to encourage wilting and drying of the cut material.

Typical conditioning systems may employ conditioning rollers or rolls which are generally in the form of two rotatable rollers displaced from one another defining a “roll gap” therebetween. Through adjustment of the roll gap a level of conditioning applied to crop material passing between the rollers can be adjusted. Specifically, adjusting the roll gap changes the mechanical force applied to passing crop material and hence the level of conditioning applied thereto.

Different crops may require different levels of conditioning. Accordingly, in known arrangements an operator may make a manual adjustment (e.g. a mechanical adjustment using a wrench or the like) to the roll gap prior to a harvesting or cutting operation for a given crop. However, this is time consuming and typically is only done once ahead of the harvesting of a given field or another working environment. As such, it is not usually possible for the operator to account for changing field and/or conditions which may also require different conditioning levels or different conditioning settings for the conditioning system. For example, a higher crop throughput may necessitate different conditioning settings to apply the same desired level of conditioning to the crop material when compared with a low crop throughput. A wetter crop—i.e. one with a higher moisture content—may require an increased level of conditioning when compared with a drier crop. It may also be beneficial to balance the power consumption associated with operating the conditioning unit, e.g. for grass crops.

It would therefore be advantageous to provide a system which may assist an operator in controlling operating settings for a conditioning system which overcomes or at least partly mitigates one or more problems associated with known systems.

### BRIEF SUMMARY

In an aspect of the invention there is provided a control system for adjusting a level of conditioning applied by a conditioning system of or otherwise associated with an agricultural machine, the control system comprising one or more controllers, and being configured to: receive pre-conditioning sensor data indicative of a first measurable property of crop material to be processed by the conditioning system; receive post-conditioning sensor data indicative of a second measurable property of crop material processed by the conditioning system; utilize the pre-conditioning sensor data and the post-conditioning sensor data to determine a crop conditioning metric; and generate and output one or more control signals for controlling operation of one or more components associated with the conditioning system in dependence on the determined crop conditioning metric.

Advantageously, the present invention utilizes sensor data and associated measurable properties of pre- and post-conditioned crop material for determining a crop conditioning metric and uses this metric to control operation of one or more components associated with the conditioning system. Pre-conditioning properties may provide information relating to a desired or suggested arrangement or operation of the crop conditioning system, and post-conditioning data may provide feedback on how the applied conditioning settings translate to the processed or conditioned crop material. Accordingly, the present solution provides a feedback loop for the conditioning system for at least partly automating control over the conditioning system or components associated therewith to control, e.g. a feed rate of material into or through the conditioning system, a roller gap to adjust a conditioning intensity or to change the gap in accordance with an observed crop thickness or the like, for example, reducing operator workload and providing more uniform or at least a desired level of processing or conditioning to a crop material without the need for manual interaction by an operator.

The one or more controllers may collectively comprise an input (e.g. an electronic input) for receiving one or more input signals. The one or more input signals may comprise the pre-conditioning sensor data and/or the post-conditioning sensor data. The one or more controllers may collectively comprise one or more processors (e.g. electronic processors) operable to execute computer readable instructions for controlling operational of the control system, for example, to determine the crop conditioning metric. The one or more processors may be operable to generate one or more control signals for controlling operation of component(s). The one or more controllers may collectively comprise an output (e.g. an electronic output) for outputting the one or more control signals.

The pre-conditioning sensor data and/or the post-conditioning sensor data may comprise image data from a vision-based sensor system. The vision-based sensor system may comprise one or more image sensors, such as a camera or a spectral imaging sensor such as a multi or hyper-spectral imaging sensor. The pre-conditioning sensor data may comprise first image data from a first image sensor. The post-conditioning sensor data may comprise second image data from the first image sensor or a separate second image sensor.

The pre-conditioning sensor data may comprise first sensor data from a first sensor type. The post-conditioning sensor data may comprise second sensor data from a sensor of the first sensor type, or sensor data from a second sensor type. For instance, the pre-conditioning sensor data and post-conditioning sensor data may comprise image data from a single or separate cameras. Alternatively, the pre-conditioning sensor data may comprise image data from a camera and the post-conditioning sensor data may comprise spectral data from a spectral imaging sensor.

The one or more controllers may be configured to analyze the image data. This may include the application of a crop feature recognition process or algorithm for identifying one or more crop constituents within the image data, or one or more measurable parameters thereof. The one or more crop constituents may comprise a stem, husk, ear, or a leaf, for example. The one or more measurable parameters may include a shape, size, color or the like of the identified crop constituents, for example. In embodiments, the first and/or second measurable parameter comprises a stem width, for example, and/or a measure of stem quality, including a measure of a “straightness” of stem components in the image data, a number of crimps or bends in identified stem components, and/or like properties indicative of crop stem quality.

Where the pre-conditioning sensor data and/or the post-conditioning sensor data comprises spectral data, the one or more controllers may be configured to analyze one or more spectral properties of the sensor data. The spectral property(ies) may be indicative of one or more crop attributes, such as a protein content, a sugar content, or ash content for the crop material for example. This may include analyzing a spectral response of the crop material, e.g. when subject to illumination by a spectral light source associated with the first or second sensors.

The one or more controllers may be configured to compare the first and second measurable properties. For example, both the first and second measurable properties may correspond to the same measurable property, and the one or more controllers may be configured to directly compare the first and second measurable properties to determine the crop conditioning metric. In embodiments, the first and second measurable properties correspond to a stem-leaf ratio for the crop material pre and post conditioning by the conditioning system. A comparison of these properties may provide a crop conditioning metric which corresponds to a measure of leaf loss or forage loss associated with conditioning system. The one or more controllers may be configured to convert the leaf loss to a crop value loss, or attribute loss, for example.

The first and second measurable properties may comprise different measurable properties, which may be dependent or independent on one another. For example, the first measurable property may correspond to a physical attribute of the crop material, which may be useful in determining an operational setting for the conditioning system, and the second measurable property may correspond to a material attribute of the conditioned material, which may be indicative of an inherent crop property and/or the effect of the applied conditioning to the material. In embodiments, the first measurable property may relate to a size or shape associated with the pre-conditioned crop material and the second measurable property may relate to a crop constituent or attribute, such as a protein content or ash content determined through analysis of the conditioned crop material.

The one or more controllers may be configured to determine a crop conditioning metric which relates to one or both of a productivity for the harvesting operation performed by the agricultural machine, or a quality measure for the harvesting operation. The one or more controllers may be programmable to prioritize either a productivity for the operation or a quality measure for the operation and control the one or more controllable components in dependence thereon.

Controlling operation of one or more components associated with the conditioning system may comprise controlling an operational parameter of the component(s).

The operational parameter for the component(s) may comprise an operational speed. Controlling the operational speed of the component(s) associated with the conditioning system may include controlling an operational speed of one or more conditioning rollers of the conditioning system. Advantageously, the control system may be configured to control the operational speed of the conditioning system or one or more components thereof in dependence on the crop conditioning metric. Changing the operational speed of the conditioning system may directly correspond to a change in a degree of conditioning applied by the material. Accordingly, the control system may be configured to adjust the operational speed to adjust the degree or level of conditioning applied in dependence on the determined metric.

Controlling the operational speed of the component(s) associated with the conditioning system may include controlling a feed rate of crop material to and/or through the conditioning system. The one or more components controllable by the one or more controllers may include a feed or “helper” roller for controlling a feed rate of material to the conditioning system. In embodiments, the one or more components may comprise a drive control system for the agricultural machine. The one or more controllers may be configured to utilize the drive control system to control a forward speed of the agricultural machine in dependence on the determined metric. Adjusting the forward speed of the machine may advantageously adjust a feed rate of material to and through the conditioning system. The feed rate may directly correspond to a degree or level of conditioning applied by the conditioning system.

The one or more controllers may be configured to control operation of a speed control subsystem for controlling the operational speed of the component(s) associated with the conditioning system. The speed control subsystem may include a drive system, such as a variable belt drive. The speed control subsystem may include a hydraulic control system, which may include hydraulic control of a motor speed associated with the controllable components.

The operational speed may comprise a relative operational speed. The control system may be operable to account for a forward speed of the agricultural machine in determining the operational speed for the controllable component. For instance, and as discussed, a higher forward speed for the machine may provide a higher feed rate for crop material when compared with a lower forward speed. Accordingly, the control system may be configured to adjust an operational speed of the component(s) relative to the forward speed of the agricultural machine, e.g. to achieve a desired feed rate or process rate for crop material through a conditioning system of the machine.

In further embodiments the one or more controllers may be configured to receive additional sensor data indicative of an operational speed of the one or more components associated with the conditioning system. This may include sensor data from a speed sensor operably coupled to the controllable component(s). The speed sensor may include a hall-effect sensor, for example. The one or more controllers may be configured to utilize the monitored speed in a feedback loop for controlling the operational speed of the component(s)—e.g. for confirming the actual operational speed is in line with the controlled or desired operational speed as determined and controlled by the control system.

The one or more controllable components may comprise a component positioning system for controlling a position or displacement of one or more components of the conditioning system. This may comprise a component positioning system for controlling a conditioning roller displacement or “roll gap” associated with the conditioning system. The one or more controllers may advantageously be configured to set the roll gap in dependence on the determined crop conditioning metric, e.g. to increase the roll gap where the metric is indicative of over-conditioning or the crop material or decrease the roll gap where the metric is indicative of an under-conditioning of the crop material, for example.

The component positioning system may comprise one or more actuators for controlling the displacement of the component(s). The one or more actuators may form part of a fluid (e.g. hydraulic or pneumatic) drive control system. The one or more controllers may be configured to adjust a control pressure associated with the fluid drive control system of the component positioning system in dependence on the crop condition metric.

In some embodiments the operational parameter relates to a level of tensioning applied by the component positioning system for the conditioning component(s). The one or more controllers may advantageously be configured to set the roller tensioning in dependence on the determined crop conditioning metric, e.g. to decrease the roller tensioning where the metric is indicative of over-conditioning or the crop material or increasing the roller tensioning where the metric is indicative of an under-conditioning of the crop material, for example.

The one or more controllable components may include a height or position control subsystem for a crop intake of the implement. The one or more controllers may advantageously be configured to utilize the height or position control subsystem for controlling a height or position of the crop intake in dependence on the first or second measurable properties and the conditioning metric determined therefrom.

The one or more controllable components may include a cutting mechanism of the implement. The one or more controllers may advantageously be configured to control operation of the cutting mechanism, e.g. through control of an operational speed of the cutting mechanism, or position of the cutting mechanism, e.g. raising or lowering of cutting element(s) of the cutting mechanism in dependence on the first or second measurable properties and the conditioning metric determined therefrom.

The one or more controllable components may comprise a user interface. The user interface, where present, may comprise a user device, e.g. a phone, tablet computer or the like carried by an operator of the machine and communicably linked to the one or more controllers, e.g. over a wireless communications network. In other embodiments, the user interface may comprise a display terminal of the agricultural machine, for example. The controller(s) may be configured to control operation of the user interface to display a graphical representation of the operation of the control system. This may include, for example, a graphical representation of the determined crop conditioning metric, the first and/or second measurable parameters, or the like. The user interface may provide a user input to the control system, for example to identify a prioritization strategy for the control system, e.g. relating to a prioritization of a productivity or quality measure for the crop condition metric and associated adjustments in component control.

A further aspect provides a conditioning system for an agricultural machine, comprising: the control system of any preceding aspect, operable in use for controlling operation of one or more components associated with the conditioning system to control a level of conditioning applied by conditioning system in dependence on the crop conditioning metric.

A yet further aspect provides an agricultural machine comprising the conditioning system and/or comprising or being controllable under operation of the control system as described herein.

The agricultural machine may comprise a self-propelled machine having the conditioning system forming part of the machine. The agricultural machine may comprise a baler, mower, harvester, or windrower, for example.

In other embodiments, the agricultural machine may comprise a vehicle-implement combination. For example, the machine may comprise a tractor or other vehicle with the implement operably coupled (e.g. towed) thereto. The conditioning system may be provided as part of the implement, and its operation may be controlled by the control system which may, in embodiments be hosted on the vehicle or the implement or distributed across both the vehicle and the implement.

A further aspect of the disclosure provides a computer implemented method for adjusting a level of conditioning applied by a conditioning system of or otherwise associated with an agricultural machine, the method comprising: receiving pre-conditioning sensor data indicative of a first measurable property of crop material to be processed by the conditioning system; receiving post-conditioning sensor data indicative of a second measurable property of crop material processed by the conditioning system; utilizing the pre-conditioning sensor data and the post-conditioning sensor data to determine a crop conditioning metric; and controlling operation of one or more components associated with the conditioning system in dependence on the determined crop conditioning metric.

The method may comprise performance of one or more operational tasks performable by the one or more controllers of a control system described herein.

A further aspect provides computer software comprising computer readable instructions which, when executed, cause performance of any method described herein.

A yet further aspect provides a non-transitory computer readable storage medium comprising the computer software of any preceding aspect.

Within the scope of this application, it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is a perspective view of an agricultural machine embodying aspects of the present disclosure;

FIG. 2 is a schematic illustration of the agricultural machine shown in FIG. 1; and

FIG. 3 is a schematic illustration of a control system of the present disclosure.

### DETAILED DESCRIPTION

The present disclosure relates to systems and methods for monitoring and controlling operation a conditioning system 28 of or otherwise associated with an agricultural machine, illustrated herein in the form of as a mower conditioner 10. Sensor data is received from sensors positioned both upstream and downstream (or at least having a field of view which encompasses material upstream and downstream, irrespective of where the sensors are actually positioned) of one or more conditioning components, here conditioning rollers 36 of the conditioning system 28. Specifically, pre-conditioning sensor data is received from a first sensor 52 positioned upstream of the conditioning rollers 36, where the pre-conditioning sensor data is indicative of a first measurable property of crop material to be processed by the conditioning system 28. Further, post-conditioning sensor data is received from a second sensor 50 positioned downstream of the conditioning rollers 36, where the post-conditioning sensor data is indicative of a second measurable property of crop material processed by the conditioning system 28. The pre-conditioning sensor data and the post-conditioning sensor data are utilized to determine a crop conditioning metric, which may be indicative of a degree of conditioning observed, or a quality of conditioning, a crop/forage loss, or the like, and this metric is used to inform control over the operation of one or more operable components associated with the conditioning system 28 in the manner discussed herein. For instance, the metric may be used to control an operational parameter of one or more component(s) associated with the conditioning system, e.g. the conditioning rollers 36 themselves, and/or a feed or helper roller 22 for controlling a flow rate of material through the conditioning system 28 and/or a level of conditioning applied to cut crop material passing through the rollers 36. Advantageously, the present solution provides a feedback loop for at least semi-automated control over operation of certain operable components associated with the conditioning system 28 to optimize or at least improve productivity or conditioning quality at, for example, different crop loads, different crop or field conditions, and the like.

### Agricultural Machine

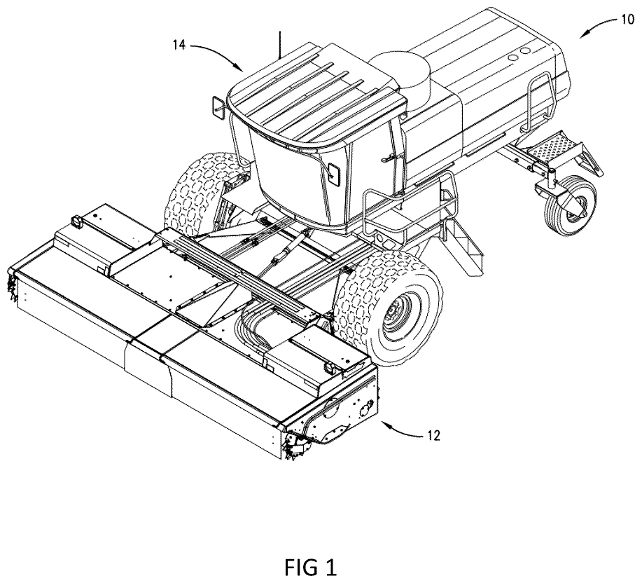

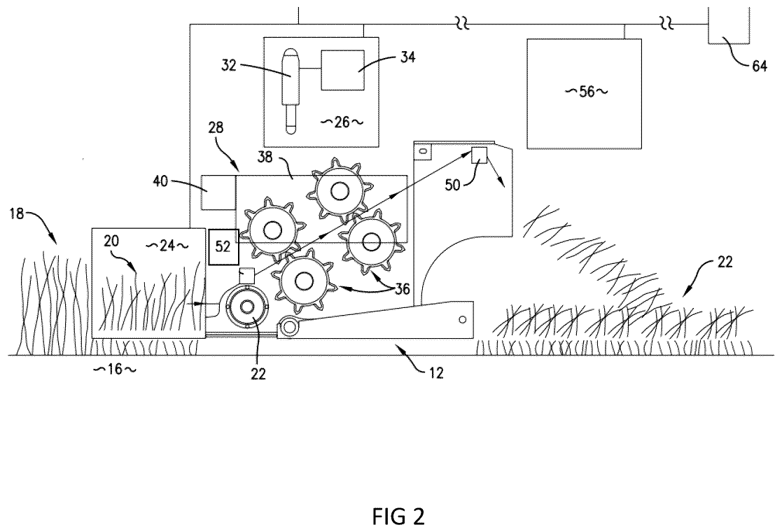

Referring to FIGS. 1 and 2, an exemplary agricultural machine in the form of a mower conditioner 10 (also referred to herein interchangeably as a “mower”) is illustrated. The illustrated mower conditioner 10 is self-propelled and includes a header 12 coupled the front thereof for cutting crop material, as will be appreciated. Specifically, the header 12 is moved over a field 16 of standing crop material 18, used to cut the crop material from the ground, condition the cut crop material 20 as it passes rearwardly through the header 12, and then return the conditioned crop material to the ground in the form of windrows or swathes 22 for drying and subsequent collection.

Referring specifically to FIG. 2, the header 12 includes a crop cutting assembly 24, a lift mechanism 26, and a conditioning system 28. The crop cutting assembly 24 is configured to cut the crop material from the ground. The crop cutting assembly 24 may employ substantially any suitable crop cutting technology, such as a conventional rotary-type cutter bed or a conventional sickle-type cutter bed. Such an arrangement will be readily understood by the skilled reader. Here, a “helper” roller 22 is provided for urging the cut crop material rearward toward the conditioning system 28, however again the skilled reader will appreciate that a number of different configurations may be employed.

The lift mechanism 26 is configured to raise and lower at least the crop cutting assembly 24 to a desired cutting height during operation, and to raise and lower the entire header 12 to, respectively, a non-operational transport height and an operational height. The lift mechanism 26 may employ substantially any suitable lifting technology, such as a hydraulic mechanism or a mechanical mechanism. Again, such an arrangement will be understood. Here, the lift mechanism 26 includes a lift cylinder 32 and a hydraulic lift circuit 34 configured to control the movement of hydraulic fluid to and from the lift cylinder 32 to, respectively, raise and lower the crop-cutting assembly 24 and/or the header 12. In some embodiments, the lift mechanism 26 is provided alongside a tilt mechanism for adjusting a “tilt” or “pitch” of the crop cutting assembly 24.

The conditioning system 28 is configured to receive and condition the cut crop material from the crop cutting assembly 24. The conditioning system 28 may employ substantially any suitable conditioning technology. Here, the conditioning system 28 includes one or more pairs of counter-rotating conditioning rollers 36 configured to “condition” the crop material. That is, as the cut crop material passes between the rollers 36, a mechanical force is applied to the material, crushing, pressing and/or crimping the material to encourage drying of the crop. To enable control over the level of conditioning applied by the rollers 36, a component positioning system in the form of tensioning mechanism 38 may be provided. Specifically, the tensioning mechanism 28 is configured to adjustably urge the paired rollers 36 toward one another and resist their separation, and a gap setting mechanism 40 is configured to set an adjustable gap between the paired rollers 36 as is described herein.

The conditioning rollers 36 may have relatively non-compressible surfaces made of a hard material and may take the form of fluted or ribbed steel rollers. Alternatively, the rollers 36 may have relatively compressible surfaces made of rubber or a combination of rubber and steel. Each roller may have a series of radially outwardly projecting ribs that extend along the length of the roller in a helical pattern. The ribs may be spaced around each roller in such a manner that the ribs on one roller intermesh with the ribs of the other paired roller during operation in order to crimp the cut crop material. Alternatively, the rollers may be non-intermeshing in order to crush rather than crimp the cut crop material. It will be appreciated here that the present disclosure is not limited in the construction of the roller surface, and this description is provided by way of example only.

Each pair of conditioning rollers 36 may be mounted in such a way that the one roller 36 is moveable toward and away from the other paired roller 36, while the position of the latter remains fixed. Alternatively, both rollers may be moveable toward and away from each other. Again, the present disclosure is not limited in this sense.

The tensioning mechanism 38 is configured to adjust a force on one or both of the paired rollers 36 to urge the rollers together to an extent permitted by the gap setting mechanism 40 which sets a running gap between or “displacement” of each pair of rollers 36. The tensioning mechanism 38 may employ substantially any suitable technology, such as hydraulic tensioning technology or spring tensioning technology. In the present embodiment, a hydraulic actuator is employed, and the control system 100 (described in detail below) may be configured in some variants to control a hydraulic pressure associated with the tensioning mechanism 38, e.g. in dependence on a determined crop conditioning metric.

In the illustrated embodiment, a speed control unit 64 is provided for controlling an operational speed of one or more components associated with the conditioning system 28. In the illustrated embodiment this comprises a hydraulic control unit for controlling an operational speed of a motor associated with one or more of the conditioning rollers 36, and in turn a rotational or working speed of the rollers 36 themselves. In the present embodiment, the control system 100 is configured to control the hydraulic control unit, e.g. through controlling of signal output, hydraulic pressure etc. for controlling the operational speed of the rollers 36 in dependence on the determined crop conditioning metric, as is described further below.

The present system further employs a sensing system, here in the form of a pair of sensors 52, 50 respectively positioned upstream and downstream of the conditioner rollers 36. The sensors 52, 50 comprise a first sensor 52 mounted to the mower 10 and positioned upstream of the conditioning rollers 36. The first sensor 52 is configured to obtain pre-conditioning sensor data indicative of a first measurable parameter of crop material to be processed by the conditioning system 28. Sensor 50 is a second sensor 50 mounted to the mower 10 and positioned downstream of the conditioning rollers 36. The second sensor 50 is configured to obtain post-conditioning sensor data indicative of a second measurable parameter of crop material which has been processed by the conditioning system 28.

In the illustrated embodiment, both first and second sensors 52, 50 comprise optical sensors in the form of cameras. The cameras 52, 50 provide pre-conditioning sensor data and post-conditioning sensor data in the form of image data which is received and processed by a central processor—e.g. processor 104 (described below)—for determining the first and/or second measurable properties from the image data, and ultimately to determine the crop conditioning metric. In the illustrated embodiment, this takes the form of the application of a crop feature recognition process for identifying and categorizing individual crop components within the imaged crop material, e.g. stems, leaves, husks, ears, cobs and the like, and quantifying this in some manner, e.g. as a stem-leaf ratio, a measure of stem segmentation or percentage stem segmentation, etc. This quantification may form the basis for the crop condition metric determination—discussed in detail below.

In variants, one or both of the cameras 52, 50 may alternatively comprise an alternative imaging or vision-based sensor, such as a LIDAR, RADAR, infrared or ultrasonic sensor, for example. In yet further alternatives, one or both of the cameras 52, 50 may be provided as a spectral imaging sensor configured to sense a spectral response of the crop material for determining one or more properties therefrom. A spectral imaging sensor may be provided in conjunction with a dedicated light source, for example, with the absorption and/or reflection of light from the light source off or from the crop material. The sensor data may be indicative of the measurable content property(ies), such as a moisture or protein content for the material.

In further variants, the first sensor 52 comprises a camera for obtaining image data of crop material upstream of the conditioning system 28, and the second sensor 50 comprises a spectral imaging sensor for obtaining spectral data indicative of a measurable content property (e.g. a protein or moisture content) of processed crop material. In such an arrangement, the pre-conditioning sensor data may be utilized to set an operational setting for the conditioning system 28, such as a roller gap or roller speed, and the post-conditioning sensor data may provide crop content information relating to a quality of the conditioned crop material, for example. The crop condition metric in this instance may comprise a comparison of the crop quality for a given conditioning arrangement.

### Operational Use

As described, in use crop material 18 is cut from the field utilizing crop cutting assembly 24. The cut crop material is passed via one or more rollers, including conditioning rollers 36 to condition the material through application of an appropriate mechanical force to crush or crimp the material to encourage, amongst other things, adequate drying of the crop when placed in a swath behind the machine. Adequate drying may relate to an overall moisture content for the crop, and/or a uniformity of the drying rate across different crop components, for example, between stems and leaves of a crop (e.g. alfalfa crop).

As discussed herein, the present solution utilizes pre-conditioning and post-conditioning sensor data for the collected crop material to determine a crop conditioning metric which quantifies the conditioning performed by the rollers 36. In turn, the crop conditioning metric is used to control one or more operable components of or otherwise associated with the conditioning system 28.

Specifically, here, the pre-conditioning and post-conditioning sensor data comprises image data from respective first and second imaging sensors in the form of cameras 52, 50, as discussed above. The image data from each camera 52, 50 is analyzed by a central processor (e.g. processor 104) for determining respective first and second measurable properties for the crop material. In the present case, the measurable properties each comprise a stem-leaf ratio for the imaged crop material, that is a stem-leaf ratio for crop material entering the conditioning system 28, as determined from image data from camera 52, and a stem-leaf ratio for crop material post conditioning, as determined form image data from camera 50. The stem-leaf ratio is calculated for each of the pre-conditioning and post-conditioning sensor data through application of a crop feature recognition algorithm, for identifying and categorizing individual crop components within the image data. This is quantified through a count (snapshot) or rolling average (analyzing the image data over time) for each of the stems and leaves identified in the image data at any given time. A comparison of the stem-leaf ratio in this way provides a crop condition metric in the form of a measure of crop or forage loss associated with the conditioning of the crop material. For instance, a relatively higher crop or forage loss may be experienced where the crop material is over conditioned compared with a scenario where an optimal or improved conditioning is provided, or indeed where the crop material is underconditioned. Accordingly, the comparison may provide a feedback loop to prevent or reduce over conditioning of the crop material, at least.

With the crop conditioning metric determined, e.g. in the manner discussed herein, this metric is used to control operation of one or more operable components of or otherwise associated with the conditioning system 28, e.g. to adjust a level of conditioning applied by the system.

For instance, gap setting mechanism 40 may be used to define a starting position for the conditioning rollers 36 between a minimum displacement, which may be defined by a hard shim stop and a maximum displacement which may largely be defined by a level of tensioning provided by a tensioning mechanism 38 of the conditioning system 28. The minimum displacement may be preset, it may be adjustable manually by an operator e.g. through mechanical interaction with the gap setting mechanism 40 utilizing appropriate tooling, or in some instances through input of a desired or target minimum roller gap utilizing, for example, a user interface 56 provided as part of the mower 10, which may be done in real-time “on the go” e.g. during performance of the harvesting operation or prior to starting the harvesting operation. The present solution may then utilize the determined crop conditioning metric to define a real-time target displacement for the rollers 36, which may include a redefinition of the minimum displacement, or defining a new target displacement between the minimum and maximum displacements. The system may then actively adjust the gap setting mechanism 40 to position, or to attempt to position, the rollers 36 at the target displacement according to the determined crop conditioning metric, determined in the manner discussed herein.

In use, once crop material is passing through the rollers, the operating gap between the rollers 36 may increase or decrease based on crop load. For instance, at high loads, the gap may increase due to the additional material. With the rollers at a greater displacement, an inadequate level of conditioning may be applied to the material. The present disclosure may therefore determine the crop conditioning metric continually or periodically, in use, such that adjustments can be made to the target gap or displacement of rollers 36 accounting for different crop conditions, crop loads, etc.

Further operational parameters for the conditioning system 28 may also be controlled in dependence on the determined crop conditioning metric. For instance, this may include controlling a rotational speed of the conditioning rollers 36. The rollers 36 may be controllable under a local speed control unit which includes a drive system, such as a variable belt drive and/or or a motor drive arrangement. The control system 100 may be operable to utilize the local control unit by adjusting the drive provided thereby to e.g. increase a rotational speed of the roller(s) 36 to manage higher crop loads, reduce the degree of conditioning of the crop or the like, as may be deemed required by the determined crop conditioning metric. Conversely, in certain circumstances, an inadequate conditioning of the crop material may be applied at higher operational speeds of the rollers 36. It may also be beneficial to reduce the operational speed of the rollers 36 for efficiency and/or fuel consumption purposes. Accordingly, the present solution may include control over the speed of the rollers e.g. by decreasing the roller speed in dependence on the determined crop conditioning metric, e.g. where the crop conditioning metric is indicative of an over conditioning of the crop material, which may be demonstrated by a high forage loss.

Yet further operational parameters may be controlled in dependence on the determined crop conditioning metric, for instance a level of tensioning applied to the rollers 36 by the tensioning mechanism. For instance, this may include control of the tensioning mechanism 38 to increase a hydraulic pressure associated with a hydraulic actuator for the roller(s) 36, thereby increasing a tensioning applied to the relevant roller(s) 36 and resisting an increase in the displacement of the rollers, in turn increasing a level or degree of conditioning applied to the crop material, for a given crop load. Conversely, the tensioning mechanism 38 may be applying too great a level of tensioning to the roller(s) 36, where the determined crop conditioning metric indicates the roller(s) displacement may be too small resulting in over conditioning of the crop material. Accordingly, the present disclosure may advantageously control operation of the tensioning mechanism 38 according to the determined crop conditioning metric. Specifically, this may include control of the tensioning mechanism 38 to decrease a hydraulic pressure associated with a hydraulic actuator for the roller(s) 36, thereby decreasing a tensioning applied to the relevant roller(s) 36 and allowing the rollers 36 to move further apart and away from a minimum or target displacement where the circumstances require.

### Control System

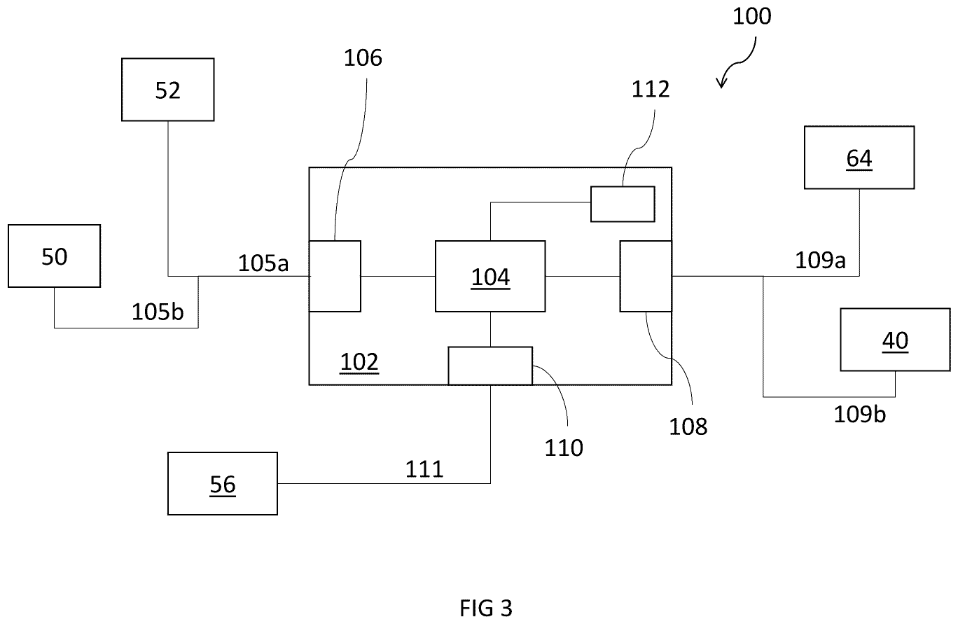

FIG. 3 illustrates system 100 of the present disclosure further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present invention, for example to output control signals 109 via the output 108 for controlling the display terminal 32 of the mower 10, for example to provide an image or graphical representation to an operator of the mower 10 indicative of the crop conditioning metric or other operational steps undertaken by the control system 100.

The processor 104 is operable to receive sensor data via input 106 which, in the illustrated embodiment, takes the form of input signals 105a received from sensor 52 and input signals 105b received from sensor 50. As described in detail herein, the sensor 52 comprises a camera (although other sensing types will be apparent), with the sensor output from the camera 52 comprising pre-conditioning image data indicative of crop material to be conditioned by the conditioning system 28. Similarly, sensor 50 comprises a camera (again, other sensing types will be apparent as discussed herein), with the sensor output from the camera 50 comprising post-conditioning image data indicative of conditioned crop material downstream of the conditioning system 28. The processor 104 is operable to analyze the image data from the cameras 52, 50 to determine a crop conditioning metric, in the manner discussed hereinabove, and utilize this to control the operation of one or more operable components associated with the conditioning system (e.g. rollers 36). For instance, depending on the determined crop conditioning metric, operation of the speed control unit 64 and/or tensioning mechanism 38, and potentially other parameters, is controlled. Here, this includes control of a hydraulic pressure associated with the hydraulic control of the rollers 36/tensioning mechanism 38, or motor control for the speed control unit 64 in the manner described herein to control the level of conditioning applied by the rollers 36. To achieve this, output 108 is operably coupled to the speed control unit 64 for output of control signals 109a thereto, and to gap setting unit 40 for output of control signals 109b thereto, for enacting an appropriate control of the operable components.

Output 110 is operably coupled to a display terminal 32 of the mower 10. Here, the control system 100 is operable to control operation of the display terminal 32, e.g. through output of control signals 111 in order to display operational data to an operator of the mower 10 relating to the operation of the control system 100. Specifically, the control system 100 may be operable to control the display terminal 32 to display to the operator a graphical representation of the crop conditioning metric, the roller displacement, or other useful information including notification of an adjustment being made for information purposes. In some variants, the display terminal 32 may also be operable to receive a user input from the operator, and in such instances the output 110 may act as an input for receiving that user input at the processor 104. The user input may relate to a requested or desired prioritization strategy for the conditioning system 28, such as a user request to prioritize a crop throughput or “productivity” for the harvesting operation, or a request to prioritize crop quality. This could additionally or alternatively include the operator inputting a desired roller gap and/or speed, or inputting other information, e.g. crop type, expected moisture level etc. from which starting operating conditions for the conditioning system 28 are determined. As will be appreciated, further displays or user interfaces may be provided for providing operational details to the operator. This could include an interface provided on or proximal to the header or crop intake of the mower itself.

### Further Alternative Embodiments

Yet further operable components may be controllable in dependence on the crop conditioning metric. For instance, the one or more controllable components may include a height or position control subsystem for a crop intake of the header 12. The one or more controllers may advantageously be configured to utilize the height or position control subsystem for controlling a height or position of the crop intake in dependence on the first or second measurable properties and the conditioning metric determined therefrom. Advantageously, adjusting the height or position of the header 12 and specifically the intake thereof may control material flow through the conditioning system 28, may reduce a level of ash content present in the collected material (e.g. as determined from an arrangement wherein a spectral analysis of the collected and conditioned material indicates a high ash content), etc.

The one or more controllable components may include a cutting mechanism of the implement, e.g. the crop cutting assembly 24. The one or more controllers may advantageously be configured to control operation of the crop cutting assembly 24, e.g. through control of an operational speed of the cutting assembly, or position of the cutting assembly, e.g. raising or lowering of cutting element(s) of the cutting assembly 24 in dependence on the first or second measurable properties and the conditioning metric determined therefrom. Again, adjusting the cutting assembly 24 in this manner may control material flow through the conditioning system 28, and/or may be utilized to reduce a level of ash content present in the collected material (e.g. as determined from an arrangement wherein a spectral analysis of the collected and conditioned material indicates a high ash content), etc.

The one or more controllable components may comprise a drive control system for the mower 10. The drive control system may be utilized to control a forward speed of the mower 10 in dependence on the determined metric. Again, adjusting the forward speed of the mower 10 may advantageously adjust a feed rate of material to and through the conditioning system 28 and hence control a level of conditioning applied by the conditioning system 28, based on the determined conditioning metric.

In yet further alternative arrangements, display terminal 56 may instead be replaced or supplemented by a user device, e.g. a remote or portable user device which is communicably coupled with the control system 100. This may enable the operator to utilize a mobile phone or tablet computer, for example, to control operation of the control system 100, e.g. by inputting desired prioritization strategy via the user device.

Whilst described herein in relation to a mower conditioner 10, the skilled reader will appreciate that the described solution may be applied to any number of self-propelled agricultural machines which utilize conditioning equipment for the conditioning of crop material, such as forage crops. This may extend to balers, other mowers, harvesting equipment and the like. This may additionally extend to implements for performance of the same task, which are coupleable to other vehicles, including tractors and the like. Where hosted on an implement rather than a self-propelled machine, the control aspects may in some instances be provided locally, or be provided by the towing or coupled vehicle, and a suitable communication link between the vehicle and the implement may be established to enable control of operable components of the implement from the vehicle, and vice versa.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device, or integrated circuits or on an optically or magnetically readable medium such as, for example, a CD, DVD, magnetic disk, or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine-readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A control system for adjusting a level of conditioning applied by a conditioning system of or otherwise associated with an agricultural machine, the control system comprising one or more controllers, and being configured to:
receive pre-conditioning sensor data indicative of a first measurable property of crop material to be processed by the conditioning system;
receive post-conditioning sensor data indicative of a second measurable property of crop material processed by the conditioning system;
utilize the pre-conditioning sensor data and the post-conditioning sensor data to determine a crop conditioning metric; and
generate and output one or more control signals for controlling operation of one or more components associated with the conditioning system in dependence on the determined crop conditioning metric;
wherein the pre-conditioning sensor data and/or the post-conditioning sensor data comprises spectral data, and the one or more controllers are configured to analyze one or more spectral properties of the sensor data.

2. A control system of claim 1, wherein the pre-conditioning sensor data and/or the post-conditioning sensor data comprise image data from a vision-based sensor system.

3. A control system of claim 2, wherein the vision-based sensor system comprises one or more image sensors; and wherein the pre-conditioning sensor data comprises first image data from a first image sensor; and the post-conditioning sensor data comprises second image data from the first image sensor or a separate second image sensor.

4. A control system of claim 1, wherein the one or more controllers are configured to compare the first and second measurable properties.

5. A control system of claim 1, wherein the first and second measurable properties comprise different measurable properties, which are dependent or independent on one another.

6. A control system of claim 1, wherein the one or more controllers are configured to determine a crop conditioning metric which relates to one or both of a productivity for the harvesting operation performed by the agricultural machine, or a quality measure for the harvesting operation; and wherein the one or more controllers are programmable to prioritize either a productivity for the operation or a quality measure for the operation and control the one or more controllable components in dependence thereon.

7. A control system of claim 1, wherein controlling operation of one or more components associated with the conditioning system comprises controlling an operational parameter of the component(s); wherein the operational parameter for the component(s) comprises an operational speed for the components; and wherein the one or more controllers are configured to control an operational speed of one or more conditioning rollers of the conditioning system in dependence on the conditioning metric.

8. A control system of claim 1, wherein the one or more controllable components comprise a drive control system for the agricultural machine; and wherein the one or more controllers are configured to utilize the drive control system to control a forward speed of the agricultural machine in dependence on the determined metric.

9. A control system of claim 1, wherein the one or more controllable components comprise a component positioning system, and wherein the one or more controllers are configured to utilize the component positioning system for controlling a position or displacement of one or more components of the conditioning system in dependence on the crop condition metric.

10. A control system of claim 9, wherein the component positioning system controls a conditioning roller displacement or “roll gap” associated with the conditioning system; and wherein the one or more controllers are configured to set the roll gap in dependence on the determined crop conditioning metric.

11. A control system of claim 9, wherein the operational parameter relates to a level of tensioning applied by the component positioning system for the conditioning component(s); and wherein the one or more controllers are configured to set the roller tensioning in dependence on the determined crop conditioning metric.

12. A control system of claim 1, wherein the one or more controllable components include a height or position control subsystem for a crop intake of the implement; and wherein the one or more controllers are configured to utilize the height or position control subsystem for controlling a height or position of the crop intake in dependence on the first or second measurable properties and the conditioning metric determined therefrom.

13. A control system of claim 1, wherein the one or more controllable components include a cutting mechanism of the implement; and wherein the one or more controllers are configured to control operation of the cutting mechanism through control of an operational speed of the cutting mechanism, or position of the cutting mechanism, including raising or lowering of cutting element(s) of the cutting mechanism in dependence on the first or second measurable properties and the conditioning metric determined therefrom.

14. A control system of claim 1, wherein the one or more controllable components comprise a user interface; and wherein the controller(s) are configured to control operation of the user interface to display a graphical representation of the operation of the control system, including one or more of a graphical representation of the determined crop conditioning metric, the first and/or second measurable parameters.

15. A conditioning system for an agricultural machine, comprising: the control system of claim 1, operable in use for controlling operation of one or more components associated with the conditioning system to control a level of conditioning applied by conditioning system in dependence on the crop conditioning metric.

16. An agricultural machine comprising the conditioning system of claim 15.

17. A computer implemented method for adjusting a level of conditioning applied by a conditioning system of or otherwise associated with an agricultural machine, the method comprising:
receiving pre-conditioning sensor data indicative of a first measurable property of crop material to be processed by the conditioning system;
receiving post-conditioning sensor data indicative of a second measurable property of crop material processed by the conditioning system;
utilizing the pre-conditioning sensor data and the post-conditioning sensor data to determine a crop conditioning metric; and
controlling operation of one or more components associated with the conditioning system in dependence on the determined crop conditioning metric;
wherein the pre-conditioning sensor data and/or the post-conditioning sensor data comprises spectral data, and the method comprises analyzing one or more spectral properties of the sensor data.
